(19) United States
(12) Patent Application Publication
(10) Pub. No.: US 2015/0287107 A1
(43) Pub. Date: Oct. 8, 2015

(54) RADIO SEARCH APPLICATION WITH FOLLOWER CAPABILITY SYSTEM AND METHOD

(71) Applicant: Hitch Radio, Inc., Santa Monica, CA (US)

(72) Inventors: Ayinde O. Alakoye, Santa Monica, CA (US); Jason Medeiros, Santa Monica, CA (US)

(21) Appl. No.: 14/678,735

(22) Filed: Apr. 3, 2015

Related U.S. Application Data
(60) Provisional application No. 61/974,985, filed on Apr. 3, 2014.

(51) Int. Cl. G06Q 30/02; G06Q 50/00

(52) U.S. Cl. CPC G06Q 30/0277; G06Q 50/01

(57) ABSTRACT

A Hitch Radio system and method are disclosed and the system may include an application that combines the fun of instant messaging with the power of real-time search. The Hitch Radio system and method allows a user to hear a song on the radio and be able to share the song with a friend.

### PRIORITY CLAIMS/RELATED APPLICATIONS

This application claims the benefit under 35 USC 119(e) to U.S. Provisional Patent Application Ser. No. 61/974,985, filed on Apr. 3, 2014 and entitled “Radio Search Application With Follower Capability”, the entirety of which is incorporated by reference herein.

### FIELD

The application relates generally to a system and method for searching radio content and being able to follow another's user selection of radio content.

### BACKGROUND

Listening to Radio is a past time for over 4 billion people around the globe. However, sharing the live stream has been a cumbersome problem. There are three main ways people have shared Radio in the past.

First, while listening to Radio in the car or at home and hearing a song or news item, people would “phone a friend” and tell them what Radio station to tune to hear the same thing they were listening to live. This would allow them to share information and experiences with those that they cared about.

Secondly, once a friend was made available to share the experience via telephone or video conference, the two parties would sit in silence in remote locations enjoying the content together either from one of the callers devices or in an unsynchronized fashion from both devices playing at the same time (two people in the same town listening to the same live broadcast Radio station at the same time). Other media is used in this way as well as in starting a movie at the same time as your friend in another town to have the “experience” of watching a movie with your friend even though the two parties are in remote locations.

Recently, as people have become more mobile, text messages have been sent with screenshots of what people were listening to at the moment, or videos with live Radio playing in the background, or texts are being sent directing their friends to go to a particular app or Radio station. In some cases, because it is not yet general knowledge that this can be shared live, people have settled for using social media or these texts to simply list the song, artist or story without the ability to provide a link for their friends to join them in real-time.

### BRIEF DESCRIPTION OF THE DRAWINGS

FIG. 1 illustrates an example of an implementation of a Hitch Radio system;

FIG. 2 illustrates an example of another implementation of a Hitch Radio system;

FIG. 3 illustrates a method for Hitching to a radio selection of another user by using the Hitch Radio system;

FIG. 4 illustrates an example of a data schema that supports the Hitch Radio system;

FIG. 5 illustrates an example of a home user interface screen of a particular user of the Hitch Radio application;

FIG. 6 illustrates an example of a my Ride user interface screen of a particular user of the Hitch Radio application;

FIG. 7 illustrates an example of a Taps user interface screen of a particular user of the Hitch Radio application;

FIG. 8 illustrates an example of a my friends user interface screen of a particular user of the Hitch Radio application;

FIG. 9 illustrates an example of an added me user interface screen of a particular user of the Hitch Radio application;

FIGS. 10 and 11 illustrate an example of a Hitching user interface screen of a particular user of the Hitch Radio application;

FIG. 12 illustrate an example of a recent user interface screen of a particular user of the Hitch Radio application;

FIG. 13 illustrate an example of a luvit user interface screen of a particular user of the Hitch Radio application;

FIG. 14 illustrate an example of a Hitched user interface screen of a particular user of the Hitch Radio application;

FIG. 15 illustrate an example of a star drivers user interface screen of a particular user of the Hitch Radio application;

FIG. 16 illustrate an example of a search user interface screen of a particular user of the Hitch Radio application; and

FIG. 17 illustrates an example of a navigation user interface screen that may be part of the Hitch Radio application.

### DETAILED DESCRIPTION OF ONE OR MORE EMBODIMENTS

The disclosure is particularly applicable to cloud or web based radio Hitching system and method for songs and it is in this context that the disclosure will be described. It will be appreciated, however, that the system and method has greater utility since the system and method can be implemented differently than described below that would be within the scope of the disclosure. The Hitching system and method may also be used for other forms of digital content streams such as television or video.

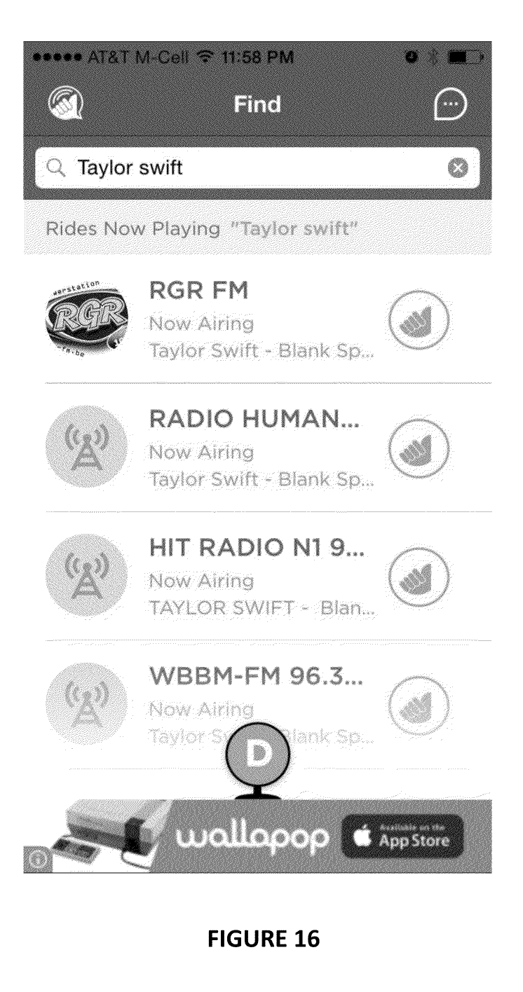

The system and method disclosed herein may be known as Hitch Radio. Hitch Radio is a way of sharing ephemeral content in an ephemeral way while allowing for one party to temporarily turn the controls over to another party for the tangible experience of real-time curation while sharing the live experience. The Hitch Radio system may include an application that combines the fun of instant messaging with the power of real-time search. The Hitch Radio system and method allows a user to hear a song on the radio and be able to share the song with a friend. The Hitch Radio system and method may have more than 20,000 radio stations listed from all around the world so that the user can type anything the user wants into a search engine (See FIG. 16 for an example of the search engine user interface) and the system and method will search the globe in real-time to find where the song is playing. The user, using the app, can then Hitch-a-Ride on that radio station and listen to the content for free. The Hitch Radio system and method allows the user to find a particular genre of music, politics, sports or entertainment using the Hitch Radio system.

The Hitch Radio system and method has a search engine by which internet content and/or live broadcast streams (Radio, Television and Video) are searched in real-time for hyper-specific, specific and/or general content with the intent of amplification or curation to a captive audience (two or more) of real-time followers. The Hitch Radio system and method also has Hitching manager by which the internet content and/or live broadcast streams (Radio, Television and Video) may be shared in real-time with a friend or group of contacts using instant messaging, email, audio, video, images or social media posts to convey short messages over live broadcasts. In one embodiment, the system may allow the users to share short messages embedded with links to live broadcast streams.

The search engine of the Hitch Radio system may search and find content in real-time broadcast radio streams using specific and/or contextual language, speech and/or semantic search technologies. The search engine may also search and find content in real-time broadcast television streams using specific and/or contextual language, speech and/or semantic search technologies. The search engine may also search and find content in real-time video streams using specific and/or contextual language, speech and/or semantic search technologies. The search engine may also search and find content in real-time broadcast Radio streams using song recognition technology for the purpose of amplifying the stream in shared consumption with a captive and/or remotely aggregated audience. The search engine may also convert static content consumption of video and audio files to real-time playlists by a function of audience (two or more people) aggregation and real-time audience funneling to online content. The search engine may also search real-time broadcast video for specific and/or contextual language and/or content. The system may use a stream monitor that will constantly check the metadata on a stream to identify what is currently playing. When there is a change in the metadata for what is playing, the system may send that change to a Search solution and the app may query the Search solution for matching results.

The application of the Hitch Radio system and method allows a user of the application to listen to the content through the content provider's player in a separate window or proxy. The system also allows the user to listen to the content through a custom player that utilizes the original stream of the content provider. The system also allows the user to listen to the content through the mobile devices' and applications in an otherwise separate and unrelated native player apart from any custom player in the app itself. Specifically, a radio station may have a stream url that delivers audio in a specific format supported by the radio stations player. Computing devices (Desktop browsers, iOS, Android, etc.) support streaming audio in their native player and each device supports a device specific streaming audio format. The method of delivering a radio station's streaming format and transcoding the stream into the different device specific formats to transcode to a format supported by a device to play the radio stations audio on the device using the devices's native audio player.

The Hitch Radio system and method may also allow one user to physically direct, redirect or transport the IP address of another user from one website to another for the collective consumption of online, offline and mobile content. The Hitch Radio system and method may permit a user to speak or announce over live broadcast streams to an aggregated online audience. The system may also instantly or in real-time match users searching real-time live broadcast content with other users and advertisers.

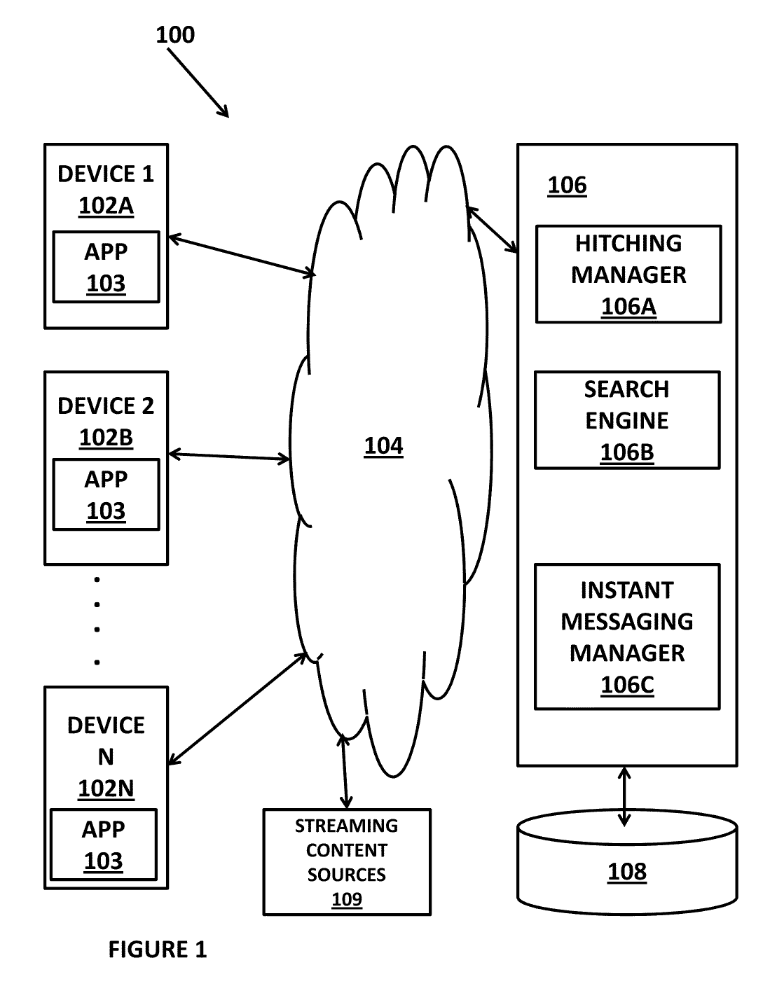

FIG. 1 illustrates an example of an implementation of a Hitch Radio system 100 that may have one or more computing devices 102 that are coupleable to a communications path 104 which is coupleable to a backend component 106 to provide a Hitch Radio functionality as described below.

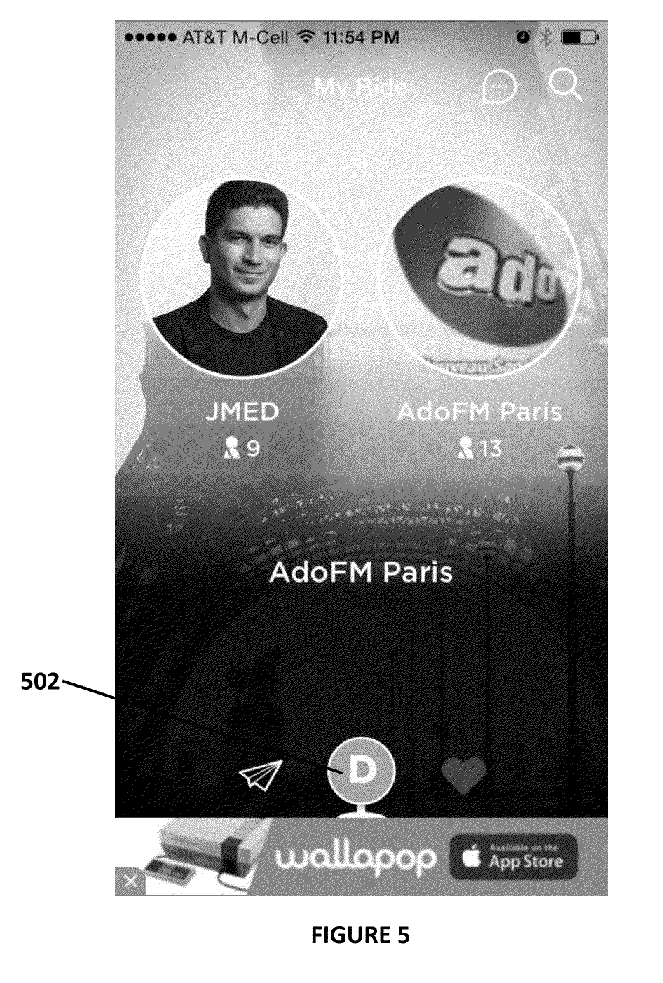

As shown in FIG. 1, the system may have the one or more computing devices 102, such as device 1 102A, device 2 102B, . . . , device N 102N, that may each couple to the communications path 104 over a known protocol and then each connect to and communicate with the backend component 106 to implement the Hitch Radio functionality to each user of each computing device. Each computing device 102 may be a processor based device that also has memory, like SRAM or DRAM, persistent storage, like flash, a display, user input devices, such as a keyboard or a virtual keyboard or a touchscreen and an ability to wirelessly or otherwise connect to the communications path 104 and communicate with the backend component 106. For example, each computing device 102 may be a smartphone device, such as an Apple® iPhone® or Android® OS based device, a laptop computer, a tablet computer, a terminal device, a cellular phone device and the like. In some embodiments, each computing device 102 may have an app 103 that is resident on the computing device or downloaded to the computing device that provides part of the functionality of the Hitch Radio system. The app 103 may by a browser application, an application or a mobile application that uses cloud services. The application may thus be a plurality of lines of computer code that may be executed by the processor of the computing device so that the processor of the computing device is configured to perform some of the Hitch Radio functionality as described below. In one embodiment, the app 103 may be the mobile application that uses cloud services. Examples of the user interface of the app is shown in FIGS. 5-17 that are described below in more detail.

The communications path 104 may be a wired or wireless network (or a combination thereof) that use a known protocol, such as HTTP, HTTPS, REST, etc. to permit each computing device 102 to couple to the communications path 104 and communicate with the backend component 106. For example, the communications path 104 may be a wired data network, such as the Ethernet, a wireless data network, a wireless or wired computer network and the like.

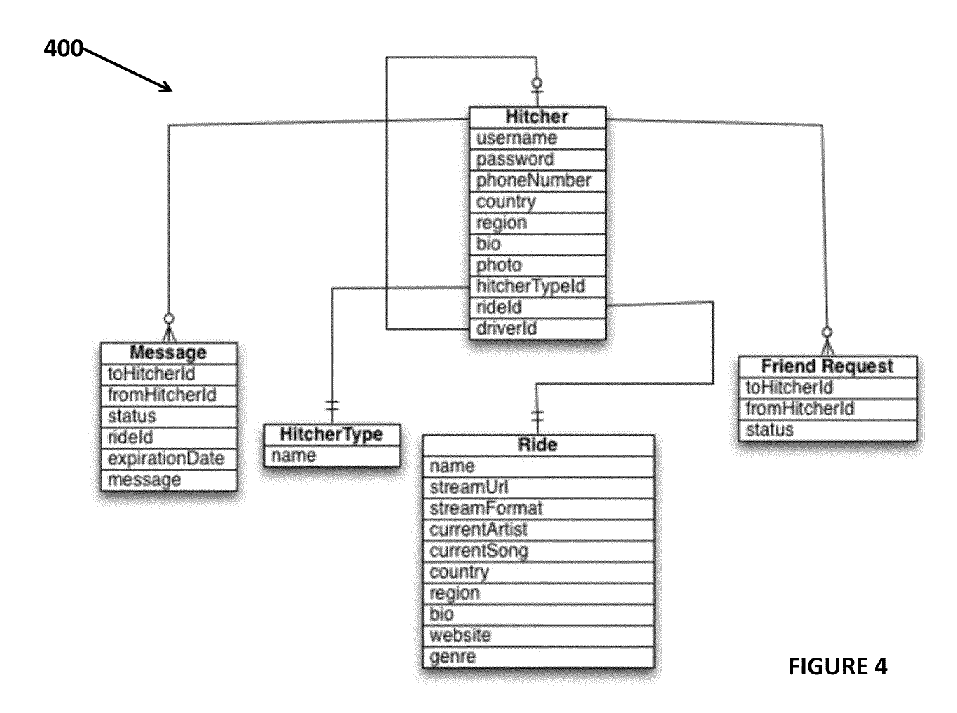

The backend component 106 may be implemented using one or more computing resources in which those computing resources may include at least one processor, storage, an application server, a database server, a server computer or other known cloud computing resources. The backend component may also be implemented in hardware as described below. The backend component 106 may comprise a Hitching manager 106A, a search engine 106B and an instant messenger manager 106C that may communicate with each other. The backend component 106 may be coupled to a store 108 that may store data used by the system such as, for example, user data and the data schema shown in FIG. 4. The backend component 106 may also be coupled to one or more streaming content sources 109. For example, in one implementation, the Hitch Radio system may have agreements with at least two streaming content providers, Abacast and Reciva, so that the Hitch Radio system may 20,000+ radio streams that may be provided in the mp3 or the AAC format. For Android based devices 102, the system may use a library to encode the AAC streams.

Each of the Hitching manager 106A, search engine 106B and instant messenger manager 106C (collectively “backend components”) may be implemented in hardware or software. When each of the backend components is implemented in software, each component may be a plurality of lines of computer code that may be resident on the computing resources of the backend component 106 and executed by a processor of the backend component 106 so that the processor is configured to perform the Hitch Radio functions as described below. When each of the backend components is implemented in hardware, each component may be implemented in an application specific integrated circuit, a field programmable gate array, a state machine or a microcontroller so that the hardware device performs the Hitch Radio functions as described below.

Although the Hitching manager 106A, search engine 106B and instant messenger manager 106C are shown in FIG. 1 as being part of the backend component 106, some of all of that functionality may be resident on each computing device 102. The Hitching manager 106A may manage the Hitching of each user to another user's content stream including the star driving as described below. The Hitching manager 106A may also generate/provide information that may be used to generate the user interface of the app as shown in FIGS. 5-17.

The search engine 106B may perform the various real-time searches using, in part, the one or more streaming content sources 109 and may also generate the playlists from the streaming content. In order to be able to perform the real-time search, the search engine may use an API of the one or more streaming content sources 109 to gather metadata about the streams like the current song, artist, station name etc. In addition, for content streams that do not have an API and to be able constantly obtain the metadata from the over 20,000 radio stations, the search engine executes their streams on a very regular basis. The search engine may have a CSV with all of the stream URL's and they may be fed into a job scheduler of the search engine which executes the URL's of each feed at a set time frame (e.g. 500 threads that process jobs that repeat every 1 second). This means that every 1 second, 500 threads will be executed where the name of the radio station, song, artist etc. will be extracted.

This metadata may be loaded into a database that may be built, in one implementation, using a known Parse® system. In some embodiments, the backend component 106 may be built in Parse® and it can be developed quickly, it is scalable and there are little or no maintenance/server costs.

Returning to the gathering of the metadata, If 500 threads are executed per second that constitutes 500 calls. The reality is that, out of those 500 threads that are executed, very few of them will be processed within the 1 second time frame. Some of the threads take a lot longer to execute (up to 20 seconds). If 500 were being executed every second that would mean that every 40 seconds the metadata from every radio station of the 20,000 would be refreshed which would be close to real time.

The instant messenger manager 106C may provide the ability for each user to send a selected content stream to another user using instant messaging. In one implementation of the system, the instant messenger manager 106C may use polling within the app 103 and the time interval of which can be adjusted in the Settings for each app 103. Alternatively, the instant messenger manager 106C may use push notifications for the instant messaging.

The Hitch Radio system and method thus combines the power of real-time search with instant messaging. This will allow users to share their favorite content, such as songs, that they are listening to at any given moment with their friends in real-time. The message may have a life-span of a defined period and when the message expires so too will the content. In many ways this makes a lot of sense as if you are sharing a song that is playing on the radio at this moment in time since the message won't be relevant in 10 minutes so there would be no real point in being able to open/view a message in which the content has already expired.

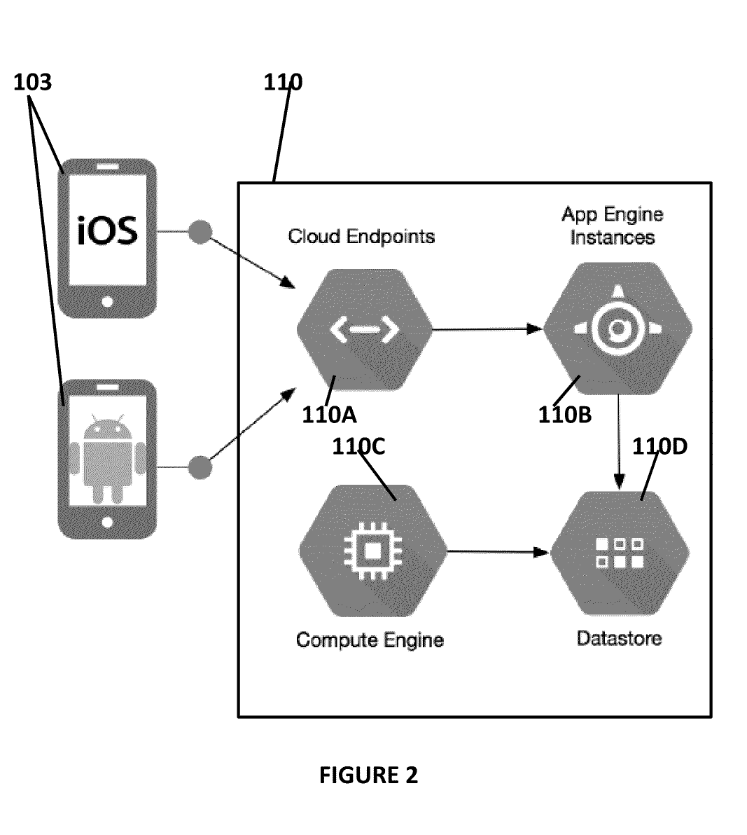

The system described above may be implemented as shown in FIG. 1, but may also be implemented using Google cloud services as shown in FIG. 2 and described below. In addition, in other embodiments, the backend component 106 may be built using PHP or Ruby. The system may also be implemented, in some embodiments, using App Engine or Big Query.

FIG. 2 illustrates an example of another implementation of a Hitch Radio system 100 that has the computing devices 102 and the apps 103 and a Google cloud services 110 that may be used to implement the backend components described above. As shown in FIG. 2, the system may be implemented using cloud endpoints 110A, an App engine instance 110B, a compute engine 110C and a datastore 110D which are each Google cloud services. The cloud Endpoints 110A are the api's that the applications will use to interact with the Hitch Radio backend. The App Engine Instances 110B are where the Cloud Endpoints will be installed and configured. The Datastore 110D is where all Hitch Radio data will be stored. Cloud Endpoints will read and write data to the Datastore 110D. The Compute Engine 110C is where other services are installed and configured that read and write data to the Datastore i.e. Stream monitor's. Applications will not have access to Compute Engine. Application's will not have access to the Datastore. Applications only have access to Cloud Endpoints. The system shown in FIG. 2 operates similarly to the system in FIG. 1 and thus its operation is not described here.

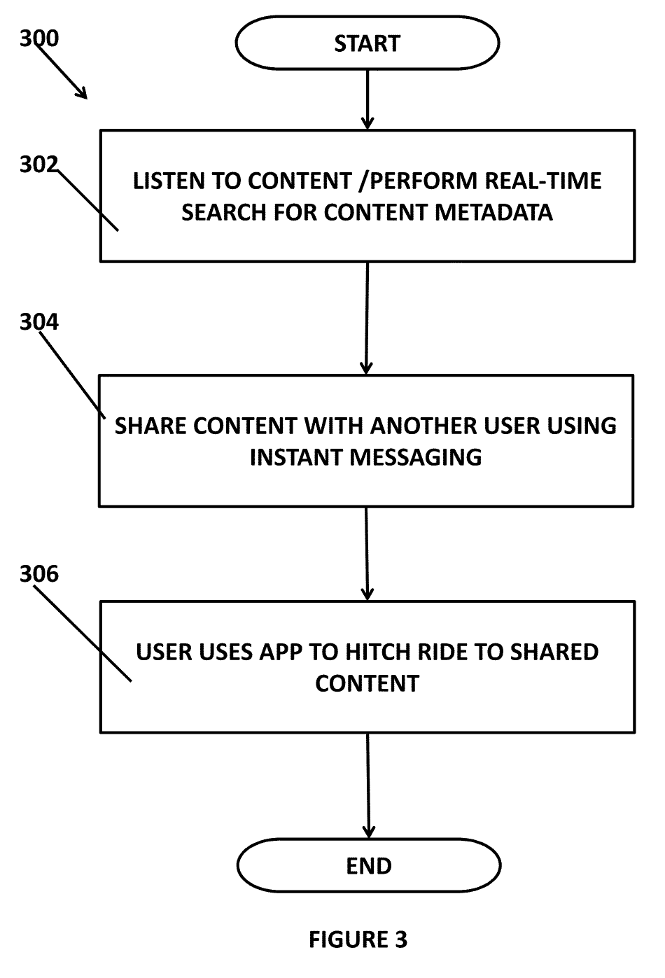

FIG. 3 illustrates a method 300 for Hitching to a radio selection of another user by using the Hitch Radio system. In the method, a user may listen to content and/or perform a real time search for content metadata (302) using their app. The user may then share the content with another user using instant messaging (304) using the instant messaging manager. The user who has the content shared with them may then use the app to access the shared content (306). This same type of process may also be used during the star driving process described below.

FIG. 4 illustrates an example of a data schema that supports the Hitch Radio system in the Parse system. This data schema and its data may be stored in the store 108 of the system. The data schema may include a message table, a Hitcher table, a friend request table and a Ride table.

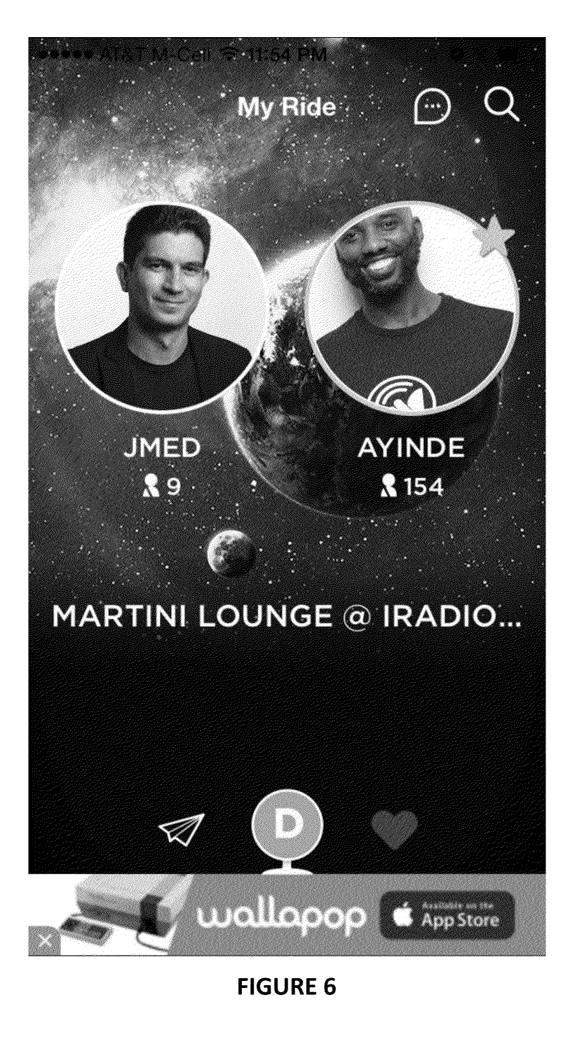

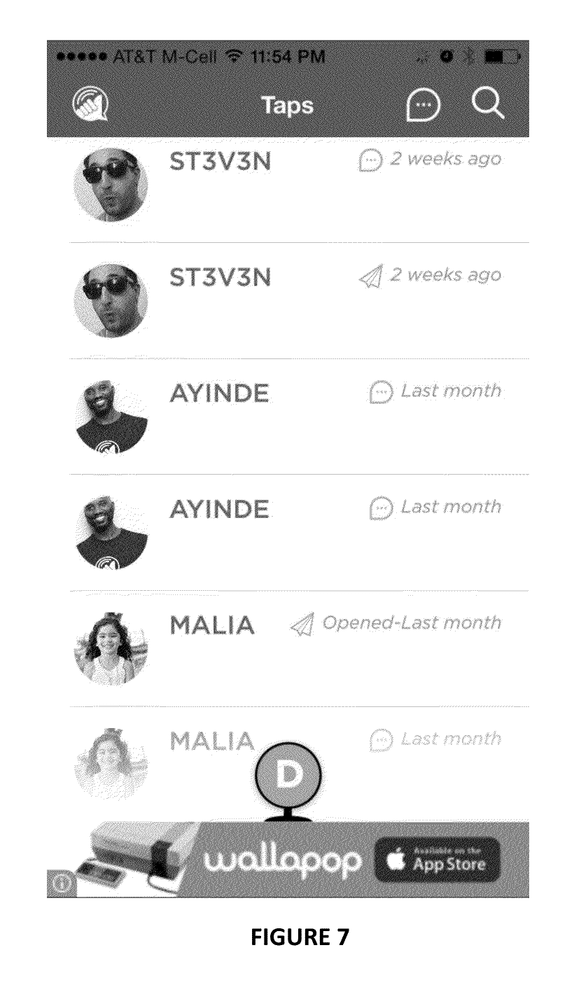

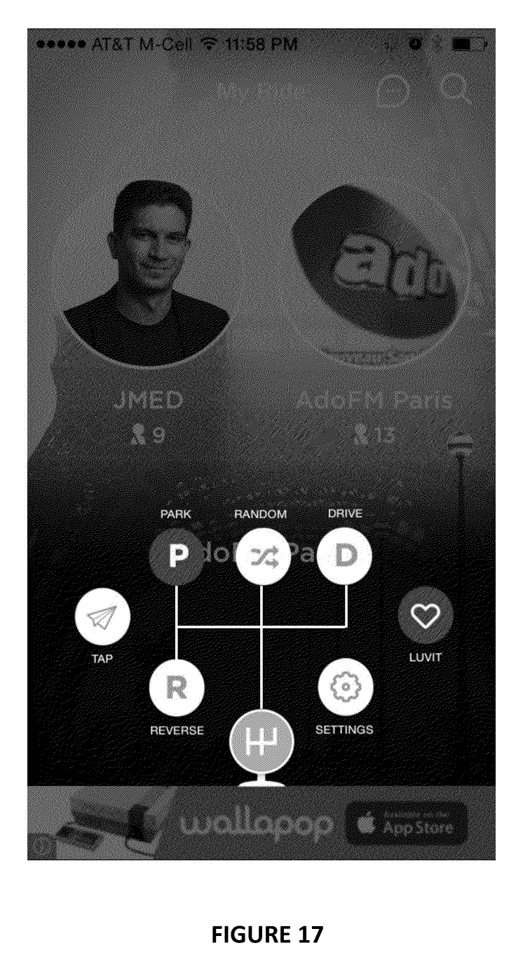

FIG. 5 illustrates an example of a home user interface screen of a particular user of the Hitch Radio application. The user interface may include a navigation feature 502 shown in a docked position. FIG. 17 shows the navigation feature in an active/undocked position in which the user can control the functions of the Hitch Radio system. FIG. 6 illustrates an example of a my Ride user interface screen of a particular user of the Hitch Radio application in which the user is Hitching-a-Ride with another user, Ayinde in this example. FIG. 7 illustrates an example of a Taps user interface screen of a particular user of the Hitch Radio application. This figure is a record of all of your “live” and “dead” Taps. When someone sends a user a Tap, the user can access it here. Taps last from 3-9 minutes from the time it is sent (the message lasts as long as a song, sporting moment or talk segment). Opening a live Tap will allow the user to preview the Ride (or Radio station) that the Driver who sent and the Tap that the Driver wants the user to hear. If the user chooses to, the user can Hitch-a-Ride with that Driver from the opened Tap. The user can also forward the Tap instantly to all of your friends (essentially spreading a live experience of a song, artist, interview, DJ, sporting event, or news segment.)

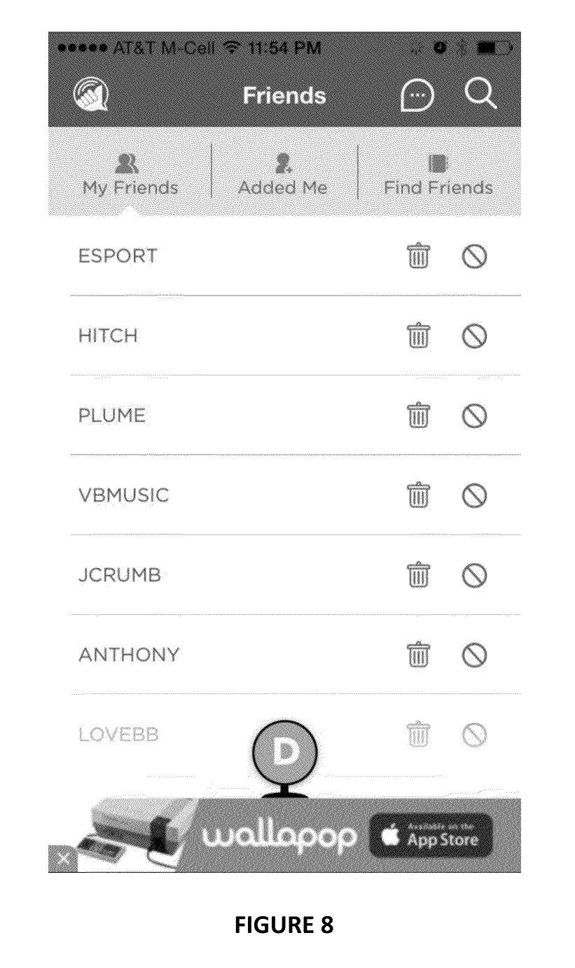

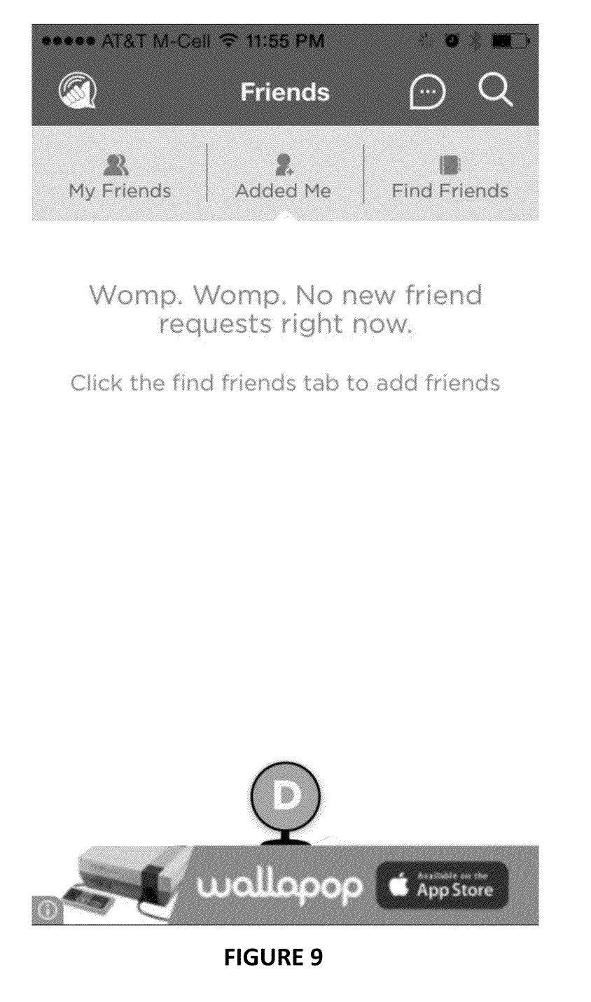

FIG. 8 illustrates an example of a my friends user interface screen of a particular user of the Hitch Radio application and FIG. 9 illustrates an example of an added me user interface screen of a particular user of the Hitch Radio application. Thus, FIG. 8 user interface allows the user of the app to view his friends while the FIG. 9 user interface allows the user to accept any friend requests. As shown in both figures, the user interface also allows the user to find friends to add into the friends list.

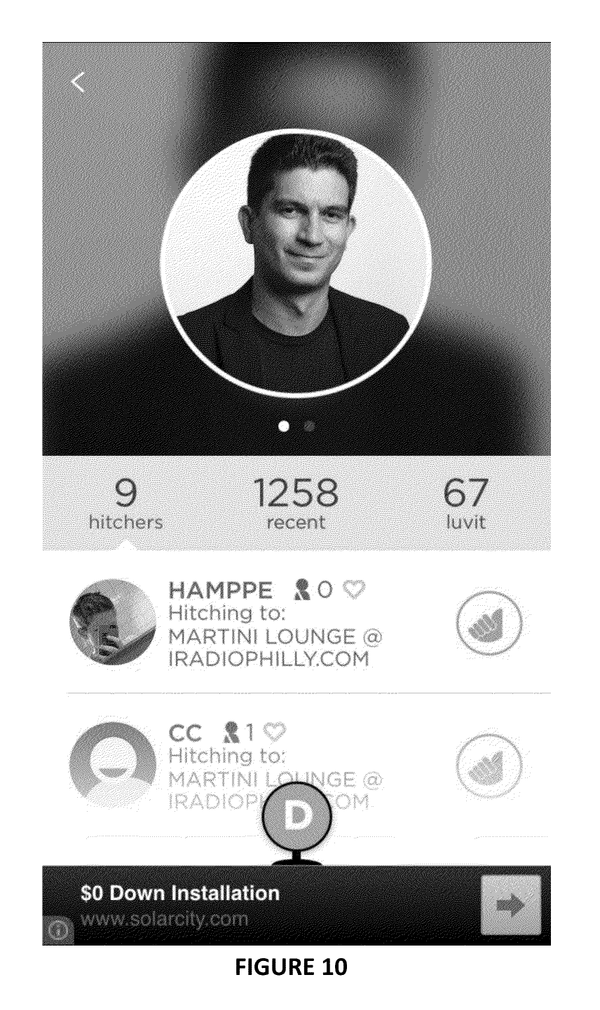

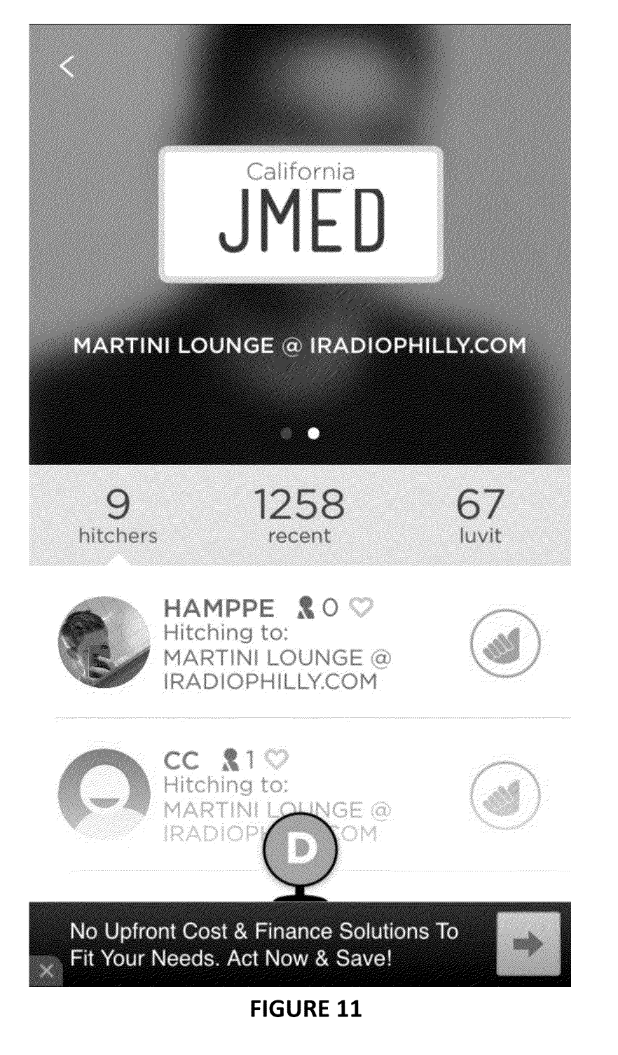

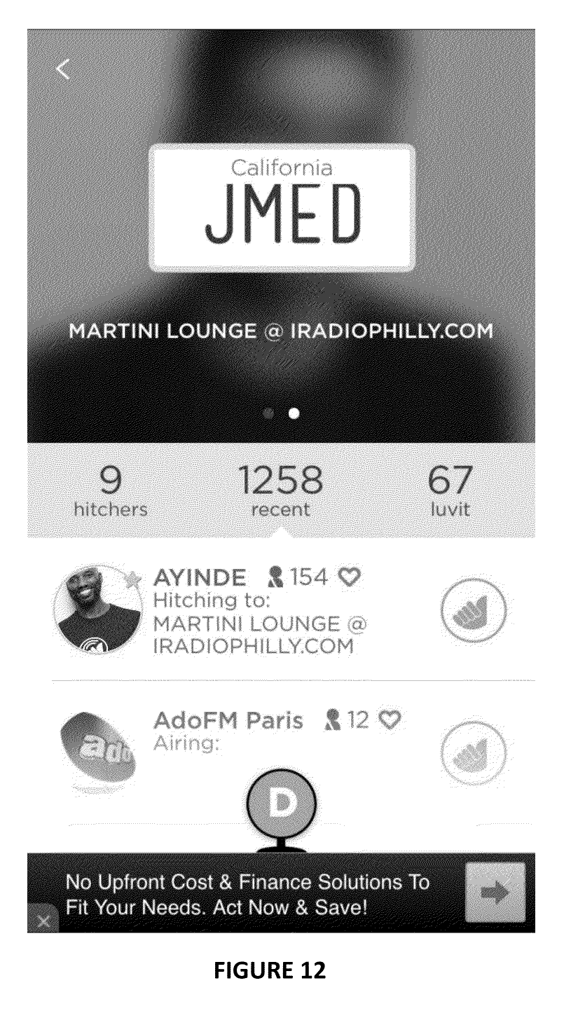

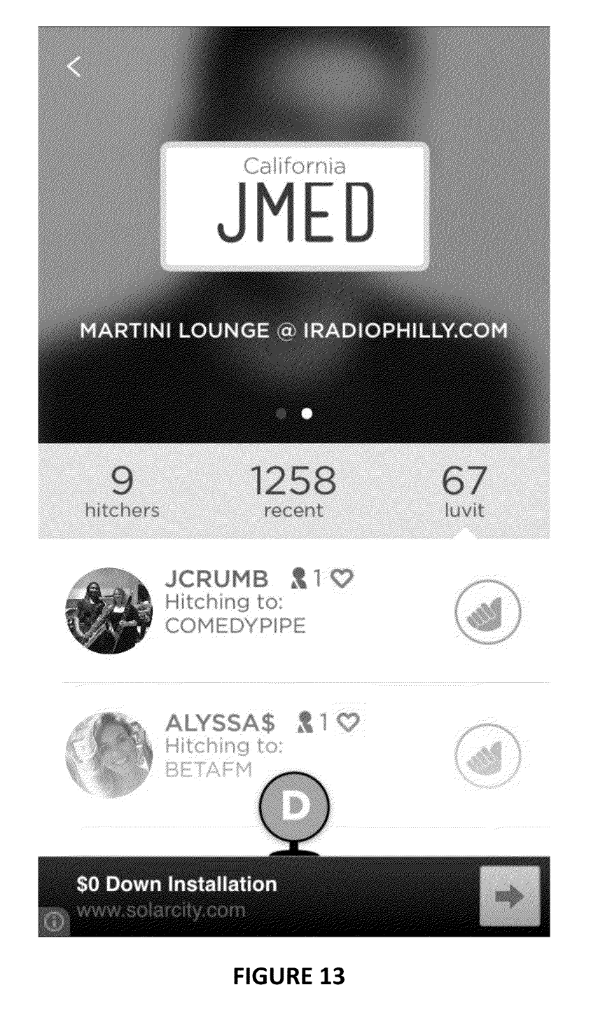

FIGS. 10 and 11 illustrate an example of a Hitching user interface screen of a particular user of the Hitch Radio application. The user interface may show the different Hitchers for the particular user (9 in this example), a number of recent content (that can be scrolled through as shown in FIG. 12) as well as content streams that are liked (luvit) by other others as shown in FIG. 13.

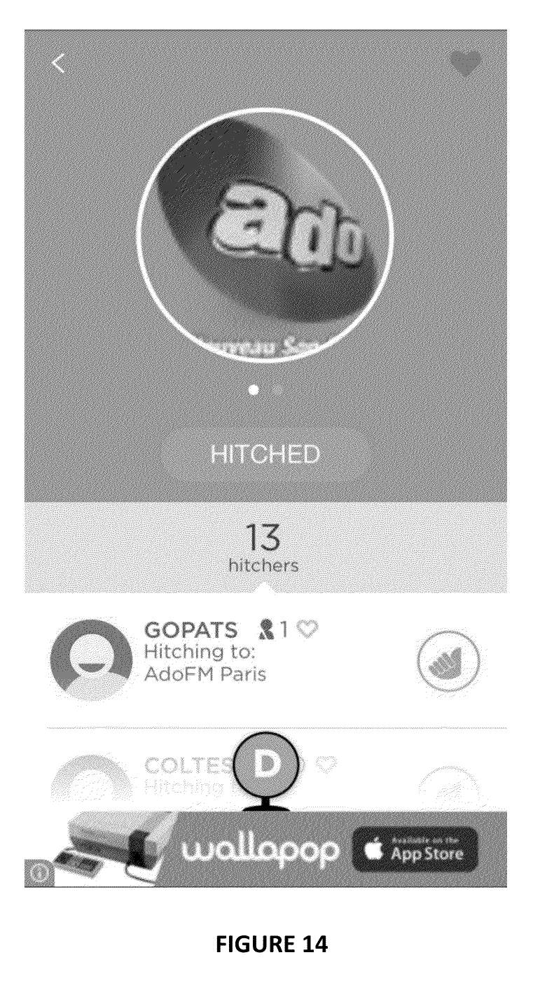

FIG. 14 illustrate an example of a Hitched user interface screen of a particular user of the Hitch Radio application that shows that the particular user is Hitched to “ado” along with 12 other Hitchers that may be scrolled through using the user interface.

Star Driving

In addition to the following/Hitching described above, the Hitch Radio system and method may also permit start driving in which one or more users may Hitch to a celebrity/star and then have their selection of content driven by the selections made by the star/celebrity. The star/celebrity can be the ‘driver’ and they can bring their thousands of followers in the app on a Ride. Whatever music the star will be listening to during the day their followers will be listening to the same music. If the star changes the station, all ‘Hitchers’ Hitched to that star will change station too. This becomes a very powerful tool for famous people to engage with their fans and followers.

The star/celebrity may be an artist or songwriter who can receive a greater payout from streaming music than typical systems like Spotify. The star driving aspect of the Hitch Radio system and method permits the artist or songwriter to invite their Twitters followers to Hitch to the artist or songwriter selected streams via instant messaging. The star driving aspect of the Hitch Radio system and method allows the artist or songwriter to earn significantly more than with traditional music streaming services.

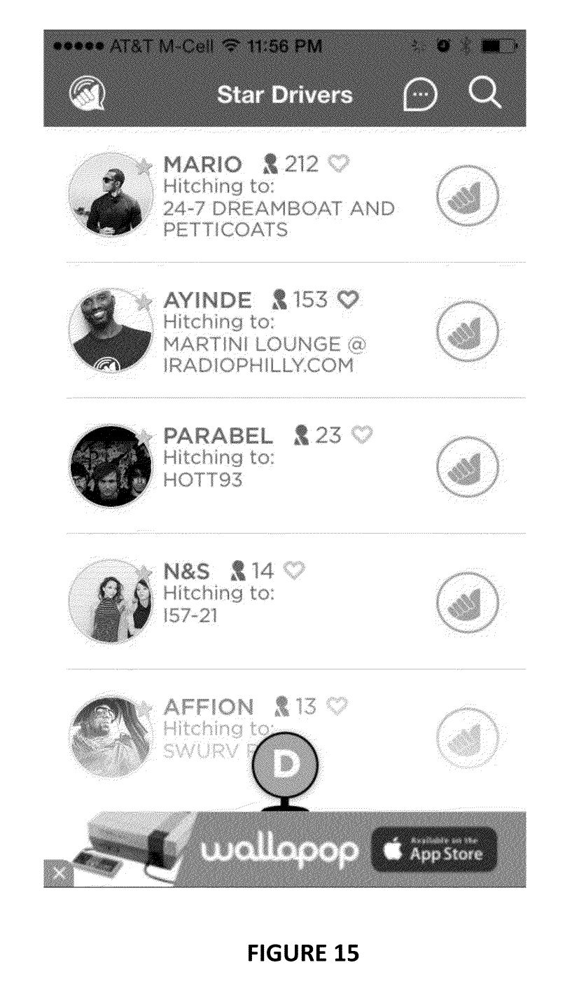

FIG. 15 illustrate an example of a star drivers user interface screen of a particular user of the Hitch Radio application. The user interface allows the user to scroll through the star drivers. FIG. 16 illustrate an example of a search user interface screen of a particular user of the Hitch Radio application. The search user interface allows the user to search for an artist, like Taylor Swift in the example in FIG. 16, and view the content streams in the systems that are currently playing the artist. The search interface allows the user to quickly identify the content streams for a particular artist, song, etc that the user can search for in real-time.

The Hitch Radio system and method may also provide advertisements. The system may have an audio signature ad (:01-:02) that will play during the buffering between Rides (Radio stations). These ads can be connected to the banner on the bottom as shown in the example user interface screens.

In addition to the driving for a content stream, the driving can be applied to web surfing. Specifically, the system may have particular uses for personal shoppers to have Hitchers and help them make purchases in retail places, parents taking the kids shopping, women shopping together. Furthermore, the system may permit Hitching-a-Ride on a celebrity who drives the user to different articles the celebrity is reading and then to see a movie online/or youtube video. It is the ability to make linear experiences social outside of audio and anywhere on the net.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A system, comprising:
an app on each of one or more computing devices;
a backend component that is capable of being coupled to each of the apps; and
wherein the app permits a user to share a content stream of the backend component using instant messaging with a second user.

2. The system of claim 1, wherein the content stream is a radio stream.

3. The system of claim 1 further comprising a Hitching manager that provides star driving in which a celebrity shares their content stream with other users.

4. The system of claim 1 further comprising a search engine that provides a real-time search of one or more pieces of metadata associated with the content streams.

5. The system of claim 1 further comprising one or more streaming content sources coupled to the backend component.

6. The system of claim 1 further comprising an ad component that generates an ad for the app.

7. A method, comprising:
discovering, using an app, a content stream;
sharing, using instant messaging, the content stream with a second user; and
hitching-a-Ride on the content stream using the app of the second user.

8. The method of claim 7, wherein the content stream is a radio stream.

9. The method of claim 7 further comprising star driving in which a celebrity shares their content stream with other users.

10. The method of claim 7 further comprising providing real-time search of one or more pieces of metadata associated with the content streams.

11. The method of claim 7 further comprising providing one or more streaming content sources coupled to the backend component.

12. The system of claim 7 further comprising generating an ad for the app.
